(19) United States
(12) Patent Application Publication
(10) Pub. No.: US 2005/0205118 A1
(43) Pub. Date: Sep. 22, 2005

(54) Sample Washer for Drilling Cuttings and other unconsolidated and discreet medias.

(76) Inventor: Konstandinos Zamfes, Calgary (CA)

Correspondence Address: KONSTANDINOS ZAMFES, 1830 - 10TH AVE S.W., CALGARY, AB, T3C-OJ8, CA

(21) Appl. No.: 10/906,850

(22) Filed: Mar. 9, 2005

Related U.S. Application Data
(60) Provisional application No. 60/521,208, filed on Mar. 11, 2004.

(51) Int. Cl. B08B 3/00

(52) U.S. Cl. 134/95.2

(57) ABSTRACT

We disclose an apparatus and process for washing and drying and treating the drilling samples with different liquids and air or vapours. The apparatus consisting from a container with liquid supply inlet and a processed compound discharge. In this container are placed a drum of 6 dual or more screen assemblies in which the top screen is filled with sample. The liquid is sprayed in the container from the top in the each screen assembly and the air is blown from underneath. The drum is attached to a micro-vibrator which is applied the mechanical or/and ultrasonic vibrations to the drum and the samples. The combination of liquid-air mixture with vibration action saves washing time and liquid spent. After the sample is washed the liquid is drained in recycling cleaner. The drying of the sample is achieved by the hot air blowing from underneath the drum into the sample screen. The desired temperature is controlled automatically. The continuous recycling pump is pumping the used liquid through the filters in to the recirculation chamber. The dirty filters are disposable.

### BACKGROUND OF INVENTION

During the drilling of a well, mud is circulated down hole to carry away drill cuttings. The cuttings are a view into the characteristics of the drilled strata. In an active mud system, the mud is circulated in a loop; pumped from the mud tank, down hole to the drilling bit, and bring up the drilling cuttings that are sampled and have to be washed for further analysis and storage. Currently hands do the washing and in same cases the water spraying systems are used. To achieve the sample clarity the use of extreme high quantity of water is required. The continuous clear water supply is required and the continuous dirty contaminated mix discharge is required.

### BRIEF DESCRIPTION OF DRAWINGS

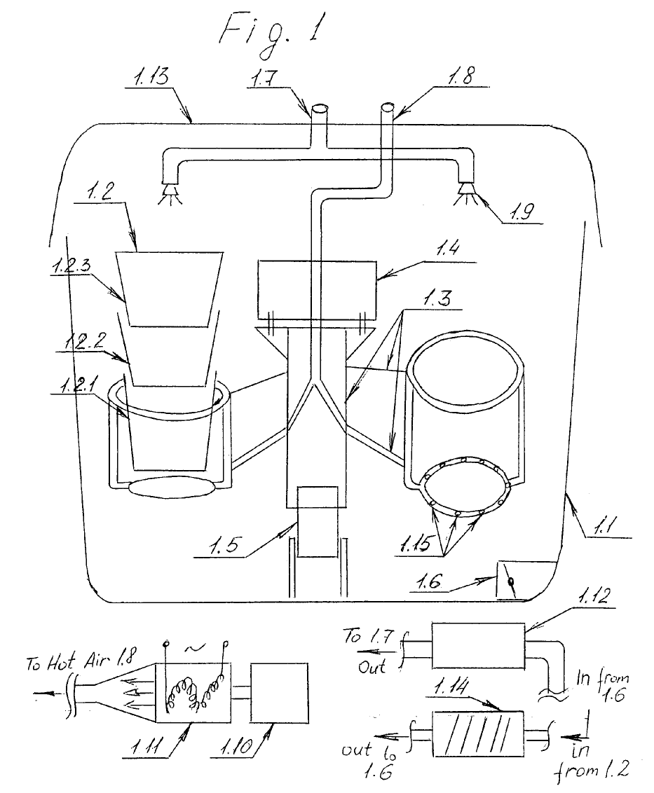

On FIG. 1 is presented a general view of sample washer-dryer.

1.1 The container.

1.2 The screen assembly that consist of 3 screens: 1.2.1 Lower screen is a screen of lower desired fraction to be retained. 1.2.2 Middle screen is the upper desired fraction to be discharged. 1.2.3 Upper screen is the coarse loader screen.

1.3 The central holding and vibration transmitting arm with 6 hollow handles for air transportation (blowing).

1.4 The Vibrator Mechanical or Ultrasonic depends on sample washing.

1.5 The rubber axial for holding the arm 1.3.

1.6 The discharge valve.

1.7 The High-Low Pressure liquid inlet.

1.8 The High-Low Pressure air/vapour inlet.

1.9 The High-Low Pressure spraying nasals.

1.10 High pressure small air pump.

1.11 Micro in line air heater.

1.12 High pressure small liquid washing pump.

1.13 Replaceable safety cover.

1.14 Liquid recycle system with discharge chambers and filters. Hot air blower.

### DETAILED DESCRIPTION

We disclose an apparatus and process for washing and drying and treating the drilling samples with different liquids and air or vapours. The apparatus consisting from a container with liquid supply inlet and a processed compound discharge. In this container are placed a drum of 6 dual or more screen assemblies in which the top screen is filled with sample. The liquid is sprayed in the container from the top in the each screen assembly and the air is blown from underneath. The drum is attached to a micro-vibrator which is applied the mechanical or/and ultrasonic vibrations to the drum and the samples. The combination of liquid-air mixture with vibration action saves washing time and liquid spent. After the sample is washed the liquid is drained in recycling cleaner. The drying of the sample is achieved by the hot air blowing from underneath the drum into the sample screen. The desired temperature is controlled automatically. The continuous recycling pump is pumping the used liquid through the filters in to the recirculation chamber. The dirty filters are disposable.

1. Apparatus for washing and drying the drilling cutting samples.

2. Combined vibrating action and air blowing through the media for increased floating effect of washing the each individual grain.

3. The use of vibrating screens for mechanical fractional size separations, which improves the washing process.

4. The use of Air bubbles to increase flotation of particles and decrease the average density of washing mass. This will also save the washing time and energy.

5. Recycling the washing liquid.

6. The Vibration Arms that caring 8 screens assembles made from low compressibility steel for high vibrant energy transmission.

7. The Screen holders those are hollow for Air transmission.
